(19) United States
(12) Patent Application Publication
(10) Pub. No.: US 2013/0268278 A1
(43) Pub. Date: Oct. 10, 2013

(54) Audio Communication System, An Audio Transmitter and An Audio Receiver

(71) Applicants: Xufang Li, Beijing (CN); Zhen Li, Beijing (CN); Yihai Xiang, Rancho Santa Margarita, CA (US); Pei Yang, Beijing (CN); Fubin Zhang, Beijing (CN)

(72) Inventors: Xufang Li, Beijing (CN); Zhen Li, Beijing (CN); Yihai Xiang, Rancho Santa Margarita, CA (US); Pei Yang, Beijing (CN); Fubin Zhang, Beijing (CN)

(73) Assignee: Beijing KT Micro, Ltd., Beijing (CN)

(21) Appl. No.: 13/526,018

(22) Filed: Jun. 18, 2012

(30) Foreign Application Priority Data
Apr. 10, 2012 (CN) 201220149419X

(51) Int. Cl. G10L 19/00

(52) U.S. Cl. CPC G10L 19/00
USPC 704/500

(57) ABSTRACT

An audio communication system, an audio transmitter and an audio receiver are described herein. In one aspect, the audio transmitter includes: An analog to digital converter configured to convert an analog audio signal into a digital audio signal; a digital compressor configured to compress the dynamic range of said digital audio signal; a digital modulator configured to modulate the compressed digital audio signal into a wireless communication signal; and the analog to digital converter, the digital compressor and the digital modulator are integrated in one integrated circuit. The described devices improve the compression and expansion device linearity, resulting in better match for the compressor at the transmitter and the expandor at the receiver.

### RELATED APPLICATIONS INFORMATION

The application claims priority under 35 U.S.C. 119(a) to Chinese application number 201220149419X, filed on Apr. 10, 2012, which is incorporated herein by reference in its entirety as if set forth in full.

### BACKGROUND

1. Technical Field

The embodiments described herein relate to microelectronics, and more specifically, to an audio communication system, an audio transmitter and an audio receiver.

2. Related Art

FIG. 1A is a schematic diagram showing a wireless microphone transmitter under the existing technologies. The wireless microphone transmitter includes a microphone 11, a first amplifier 12, an analog voltage controlled oscillator 13 and a transmitting antenna 14, the analog audio signal outputted by the microphone 11 is amplified by the first amplifier 12, the amplified analog audio signal is then converted by the analog voltage controlled oscillator 13 into an analog Frequency Modulation (FM) signal, the analog FM signal is transmitted out by the transmitting antenna 14. FIG. 1B is a schematic diagram showing a wireless microphone receiver under the existing technologies. The wireless microphone receiver includes a receiving antenna 15, a second amplifier 16, a mixer 19, an analog demodulator 17, and a speaker 18, the receiving antenna 15 receives an analog FM signal, the second amplifier 16 amplifies the analog FM signal, the mixer 19 converts the analog FM signal to a fixed Intermediate Frequency (IF) analog signal, the analog demodulator 17 demodulates the analog IF signal into an analog audio signal, the speaker 18 then converts the analog audio signal into sound.

For the transmitting and receiving systems illustrated in FIG. 1A and FIG. 1B, the signal to noise ratio is limited by the FM portion of the transmitter, since the signal to noise ratio of voltage-controlled oscillator for the FM part of the transmitter is relatively low, generally below 70 dB, therefore, the signal to noise ratio for the transmitting and receiving system is generally poor. In order to improve the signal to noise ratio in the transmitting and receiving system illustrated in FIGS. 1A and 1B, an audio companding technique has been adopted. The audio companding technology efficiently compresses the dynamic range of the audio signal at the transmitter before transmission, and expands the dynamic range of the received audio signal at the receiver; at the transmitter, not only the audio signal is compressed, but also the additional noise is compressed; at the receiver, the audio signal is expanded with reduced additional noise, resulting in a clearer voice and communication even in a noise environment.

FIG. 2A is a schematic diagram showing another wireless microphone transmitter under the existing technologies. On the basis of the schematic diagram in FIG. 1A, an analog compressor 21 is connected between the first amplifier 12 and the analog voltage-controlled oscillator 13, the analog compressor 21 includes a first variable gain amplifier 211 and a first full-wave rectifier 212, the input of the first variable gain amplifier 211 is connected to the first amplifier 12, the output of the first variable gain amplifier 211 is connected to the analog voltage controlled oscillator 13, the input of the first full-wave rectifier 212 is connected to the output of the first variable gain amplifier 211, the output of the first full-wave rectifier 212 is connected to the input of the first variable gain amplifier 211, the analog compressor 21 compresses the amplified analog audio signal. FIG. 2B is a schematic diagram showing another wireless microphone receiver under the existing technologies. On the basis of the schematic diagram in FIG. 1B, an analog expandor 22 is connected between the analog demodulator 17 and the speaker 18, the analog expandor 22 includes a second variable gain amplifier 221 and a second full-wave rectifier 222, the input of the second variable gain amplifier 221 is connected to the analog demodulator 17, the output of the second variable gain amplifier 221 is connected to the speaker 18, the input of the second full-wave rectifier 222 is connected to the analog demodulator 17, the output of the second full-wave rectifier 222 is connected to the input of the second variable gain amplifier 221, the analog expandor 22 expands the demodulated analog audio signal. In particular, since the analog compressor 21's ability to amplify weak signal is greater than its ability to amplify strong signal, the analog compressor 21 compresses the dynamic range of the signal, reducing the requirement for the signal to noise ratio of the wireless communication channel. While the analog expandor 22 restores the compressed signal to its original dynamic range.

### SUMMARY

An audio communication system, an audio transmitter, and an audio receiver are described herein. The described devices improve the compression and expansion device linearity, resulting in better match for the compressor at the transmitter and the expandor at the receiver.

In one aspect, the audio transmitter includes: An analog to digital converter configured to convert an analog audio signal into a digital audio signal; a digital compressor configured to compress the dynamic range of said digital audio signal; a digital modulator configured to modulate the compressed digital audio signal into a wireless communication signal; the analog to digital converter, the digital compressor and the digital modulator are integrated in one integrated circuit.

In another aspect, the audio receiver includes: a digital demodulator configured to demodulate a wireless communication signal into a digital audio signal; a digital expandor configured to expand the dynamic range of said digital audio signal; a digital to analog converter configured to convert the expanded digital audio signal into an analog audio signal; and the digital demodulator, the digital expandor and the digital to analog converter are integrated in one integrated circuit.

In another aspect, an audio communication system includes: an audio transmitter configured to convert an analog audio signal to a digital audio signal, to compress the dynamic range of said digital audio signal in a compressor, and to modulate the compressed digital audio signal into a wireless communication signal; and an audio receiver configured to demodulate the wireless communication signal into a digital audio signal, to expand the dynamic range of the digital audio signal in a expandor, and to convert the expanded digital audio signal into an analog audio signal.

In the present embodiments, due to the adoption of digital compandor and digital processing's precision is higher than analog processing, the linearity of the compandor has been greatly improved. Moreover, since the digital processing is not affected by the manufacturing process as much as analog processing, the compressor at the transmitter and the expandor at the receiver can have a better match.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1A is a schematic diagram showing a wireless microphone transmitter under the existing technologies;

FIG. 1B is a schematic diagram showing a wireless microphone receiver under the existing technologies;

FIG. 2A is a schematic diagram showing another wireless microphone transmitter under the existing technologies;

FIG. 2B is a schematic diagram showing another wireless microphone receiver under the existing technologies;

FIG. 3 is a schematic diagram showing an audio communication system according to one embodiment;

FIG. 4 is a schematic diagram showing an audio transmitter according to one embodiment;

FIG. 5 is a schematic diagram showing the working principle of the digital compressor in the audio transmitter according to one embodiment;

FIG. 6 is a schematic diagram showing an audio receiver according to one embodiment;

FIG. 7 is a schematic diagram showing the working principle of the digital expandor in the audio receiver according to one embodiment.

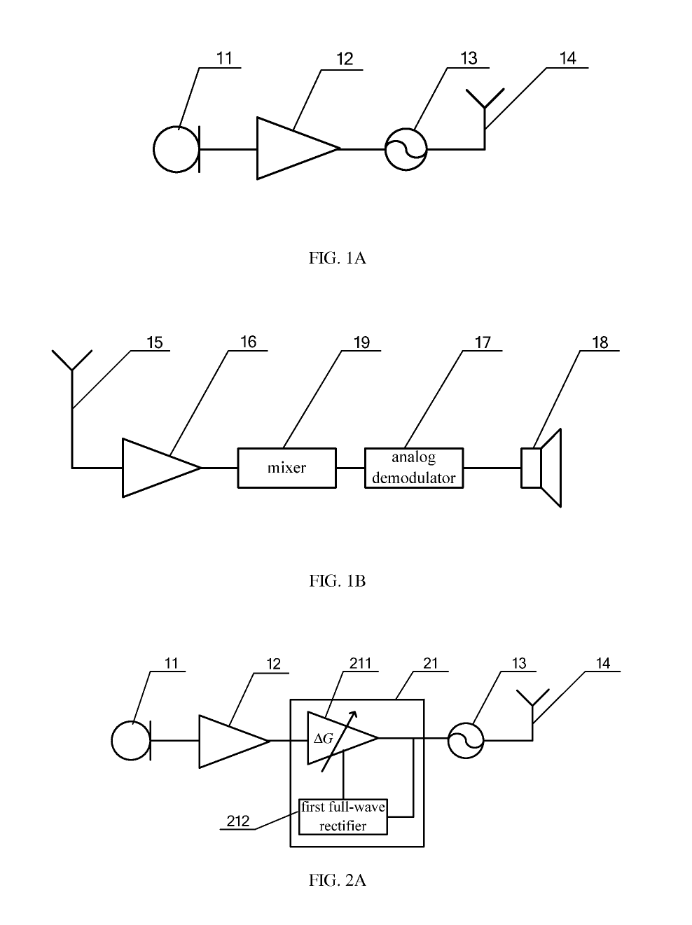

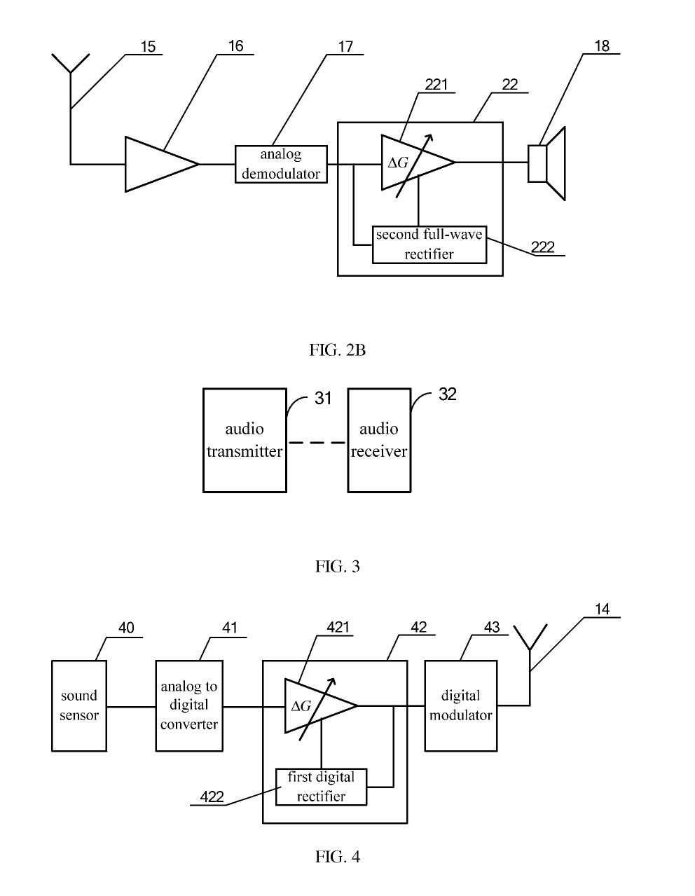

### DETAILED DESCRIPTION

Referring now to the drawings, a description will be made herein of embodiments herein.

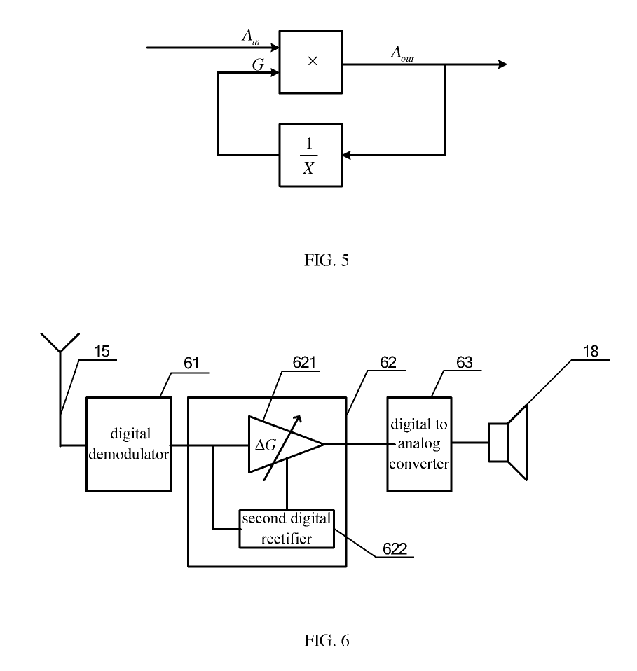

FIG. 3 is a schematic diagram showing an audio communication system according to one embodiment. The audio communication system may include an audio transmitter 31 and an audio receiver 32, the audio receiver 32 may be configured to connect to the audio transmitter 31 via a wireless link connection.

The audio transmitter 31 may be configured to convert an analog audio signal into a digital audio signal, to compress the dynamic range of the digital audio signal in the compressor, to modulate the compressed digital audio signal to a wireless communication signal.

The audio receiver 32 may be configured to demodulate the wireless communication signal to digital audio signal, to expand the dynamic range of the digital audio signal in the expandor, to convert the expanded digital audio signal to an analog audio signal.

In this embodiment, both the compressor in the audio transmitter 31 and the expandor in the audio receiver 32 may adopt the digital processing. Since digital signal processing has higher precision than analog processing, the linearity of the compandor is significantly improved. Moreover, since the digital processing is not affected by the manufacturing process as much as analog processing, the compressor at the transmitter and the expandor at the receiver can have a better match.

FIG. 4 is a schematic diagram showing an audio transmitter according to one embodiment. The audio signal transmitter may include an analog to digital converter 41, a digital compressor 42, and a digital modulator 43. The digital compressor 42 may be configured to connect to the analog to digital converter 41, the digital modulator 43 may be configured to connect to the digital compressor 42. The analog to digital conversion 41, the digital compressor 42 and the digital modulator 43 may be integrated in one integrated circuit.

In particular, the analog to digital converter 41 may be configured to convert an analog audio signal to a digital audio signal; the digital compressor 42 may be configured to compress the dynamic range of the digital audio signal; the digital modulator 43 may be configured to modulate the compressed digital audio signal into a wireless communication signal, the wireless communication signal may be a FM signal or AM signal according to one embodiment, the digital modulator 43 may be a digital voltage controlled oscillator according to one embodiment; the wireless communication signal may be transmitted by a transmitting antenna 14.

In this embodiment, the analog to digital converter 41 may be configured to convert the analog audio signal into a digital audio signal, and the digital compressor 42 may be configured to compress the dynamic range of the digital audio signal, and the digital modulator 43 may be configured to modulate the compressed digital audio signal into a wireless communication signal. Since digital processing has higher precision than analog processing, the linearity of the compandor is significantly improved. Moreover, since the digital processing is not affected by the manufacturing process as much as analog processing, the compressor at the transmitter and the expandor at the receiver can have a better match.

In one embodiment, the analog audio signal may be converted from a sound message by a sound sensor 40. The sound sensor 40 may be a microphone according to one embodiment.

In another embodiment and as illustrated in FIG. 4, the digital compressor 42 may include a first digital variable gain amplifier 421 and a first digital rectifier 422; the first digital variable gain amplifier 421 may be configured to connect between the analog to digital converter 41 and digital modulator 43; one end of the first digital rectifier 422 may be configured to connect to the first digital variable gain amplifier 421, the other end of the first digital rectifier 422 may be configured to connect between the first digital variable gain amplifier 421 and the digital modulator 43.

In particular, the first digital variable gain amplifier 421 may amplify the digital audio signal according to a predetermined gain. The first digital rectifier 422 may sense the amplitude of the amplified digital audio signal to calculate the predetermined gain.

FIG. 5 is a schematic diagram showing the working principle of the digital compressor in the audio transmitter according to one embodiment. If the amplitude of the input signal for the digital compressor Aᵢₙ, the amplitude of the output signal Aₒᵤₜ and the gain of the digital compressor G satisfy the following relationship:

Aₒᵤₜ=Aᵢₙ×G

Moreover, through the adjustment of the first digital rectifier 422, the following relationship holds:

$$G = \frac{1}{{A}_{out}}$$

Then the following can be deduced from the above two equations:

Aₒᵤₜ=\sqrt{Aᵢₙ}

As illustrated from the equation above, after dynamic range compression, the dynamic range of the audio signal is compressed to ½ of the original dynamic range. For example: an audio signal of a 110 dB dynamic range may be compressed to a 55 dB dynamic range, and then be transmitted through a FM channel with a signal to noise ratio of 60 dB FM channel transmission, resulting in high dynamic range audio signal transmission through channel with low signal to noise ratio.

In addition, in this embodiment, the digital compressor 42 may be a CMOS digital compressor, which has the advantages of low cost and ease of integration.

FIG. 6 is a schematic diagram showing an audio receiver according to one embodiment. The audio signal receiver may include a digital demodulator 61, a digital expandor 62, and a digital to analog converter 63. The digital expandor 62 may be configured to connect to the digital demodulator 61, and the digital to analog converter 63 may be configured to connect to the digital expandor 62. The digital demodulator 61, the digital expandor 62, and the digital to analog converter 63 may be integrated in one integrated circuit.

In this embodiment, the digital demodulator 61 may be configured to demodulate the wireless communication signal to a digital audio signal; the digital expandor 62 may be configured to expand the dynamic range of the digital audio signal; the digital to analog converter 63 may be configured to convert the expanded audio signal to an analog audio signal. The wireless communication signal may be received by a receiving antenna 15 and then sent to the receiver. The analog audio signal may be converted to a voice message by a speaker 18 to be broadcast.

In this embodiment, the digital demodulator 61 may demodulate the wireless communication signal into a digital audio signal, then the digital expandor 62 may expand the dynamic range of the digital audio signal, the digital to analog converter device 63 may then convert the expanded digital audio signal to an analog audio signal. Since digital signal processing has higher precision than analog processing, the linearity of the compandor is significantly improved. Moreover, since the digital processing is not affected by the manufacturing process as much as analog processing, the compressor at the transmitter and the expandor at the receiver can have a better match.

Furthermore, as illustrated in FIG. 6, the digital expandor 62 may include a second digital variable gain amplifier 621 and a second digital rectifier 622; the second digital variable gain amplifier 621 may be configured to connect between the digital demodulator and the digital to analog converter; one end of the second digital rectifier 622 may be configured to connect to the second digital variable gain amplifier 621, and the other end of the second digital rectifier 622 may be configured to connect between the second digital variable gain amplifier 621 and the digital demodulator 61.

The second digital variable gain amplifier 621 may amplify the digital audio signal according to a predetermined gain; the second digital rectifier 622 may sense the amplitude of the demodulated digital audio signal to calculate the predetermined gain.

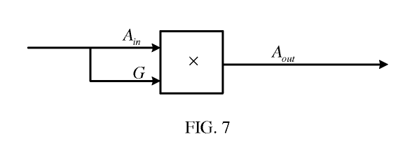

FIG. 7 is a schematic diagram showing the working principle of the digital expandor in the audio receiver according to one embodiment. If the amplitude of the input signal for the digital expandor Aᵢₙ, the amplitude of the output signal Aₒᵤₜ, and the gain of the digital compressor G satisfy the following relationship:

Aₒᵤₜ=Aᵢₙ×G

Through the adjustment of the second digital rectifier 622, the following relationship holds:

G=Aᵢₙ

Then the following can be deduced from the above two equations:

Aₒᵤₜ=Aᵢₙ²

As illustrated from the equation above, the dynamic range of the audio signal is expanded to twice the original dynamic range. For example: an audio signal of a 55 dB dynamic range may be expanded to an 110 dB dynamic range.

In addition, in this embodiment, the digital expandor 62 may be a CMOS digital expandor, which has the advantages of low cost and ease of integration.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed is:

1. An audio transmitter including:
an analog to digital converter configured to convert an analog audio signal into a digital audio signal;
a digital compressor configured to compress the dynamic range of said digital audio signal;
a digital modulator configured to modulate said compressed digital audio signal into a wireless communication signal; and
the analog to digital converter, the digital compressor and the digital modulator are integrated in one integrated circuit.

2. The audio transmitter according to claim 1, wherein the digital compressor includes:
a first digital variable gain amplifier configured to connect between the analog to digital converter and the digital modulator, and to amplify the digital audio signal based on a predetermined gain;
a first digital rectifier configured to connect to the first digital variable gain amplifier at one end, to connect between the first digital variable gain amplifier and the digital modulator at the other end, and to rectify the amplified digital audio signal;
wherein the first digital variable gain amplifier is further configured to control the predetermined gain according to the rectified digital audio signal.

3. The audio transmitter according to claim 1, wherein the digital compressor is a CMOS digital compressor.

4. The audio transmitter according to claim 2, wherein the digital compressor is a CMOS digital compressor.

5. An audio receiver including:
a digital demodulator configured to demodulate a wireless communication signal into a digital audio signal;
a digital expandor configured to expand the dynamic range of said digital audio signal;
a digital to analog converter configured to convert the expanded digital audio signal into an analog audio signal; and
the digital demodulator, the digital expandor and the digital to analog converter are integrated in one integrated circuit.

6. The audio receiver according to claim 5, wherein the digital expandor includes:
a second digital variable gain amplifier configured to connect between the digital demodulator and the digital to analog converter, and to amplify said digital audio signal based on a predetermined gain; and
a second digital rectifier configured to connect to the second digital variable gain amplifier at one end, to connect between the second digital variable gain amplifier and the digital demodulator at the other end, and to rectify the demodulated digital audio signal;
wherein the second digital variable gain amplifier controls the predetermined gain based on the rectified digital audio signal.

7. The audio receiver according to claim 7 wherein the digital expandor is a digital CMOS expandor.

8. The audio receiver according to claim 8 wherein the digital expandor is a digital CMOS expandor.

9. An audio communication system including:
an audio transmitter configured to convert an analog audio signal to a digital audio signal, to compress the dynamic range of said digital audio signal in a digital compressor, to modulate the compressed digital audio signal into a wireless communication signal; and
an audio receiver configured to demodulate the wireless communication signal into a digital audio signal, to expand the dynamic range of the digital audio signal in a digital expandor, and to convert the expanded digital audio signal into an analog audio signal.

10. The system according to claim 9, wherein the audio transmitter includes the device for transmitting an audio signal according to claim 1.

11. The system according to claim 9, wherein the audio transmitter includes the device for transmitting an audio signal according to claim 2.

12. The system according to claim 9, wherein the audio transmitter includes the device for transmitting an audio signal according to claim 3.

13. The system according to claim 9, wherein the audio transmitter includes the device for transmitting an audio signal according to claim 4.

14. The system according to claim 9, wherein the audio receiver includes the device for receiving an audio signal according to claim 5.

15. The system according to claim 9, wherein the audio receiver includes the device for receiving an audio signal according to claim 6.

16. The system according to claim 9, wherein the audio receiver includes the device for receiving an audio signal according to claim 7.

17. The system according to claim 9, wherein the audio receiver includes the device for receiving an audio signal according to claim 8.
